(19) United States
(12) Patent Application Publication
(10) Pub. No.: US 2014/0136632 A1
(43) Pub. Date: May 15, 2014

(54) Remote Customer Mail Processing

(71) Applicants: Ingolf Rauh, Reichenau (DE); Ilian Pashov, Konstanz (DE); Joseph C. Mungo, Coppell, TX (US); Michael D. Carpenter, Arlington, TX (US)

(72) Inventors: Ingolf Rauh, Reichenau (DE); Ilian Pashov, Konstanz (DE); Joseph C. Mungo, Coppell, TX (US); Michael D. Carpenter, Arlington, TX (US)

(21) Appl. No.: 13/674,327

(22) Filed: Nov. 12, 2012

(51) Int. Cl. H04L 12/58

(52) U.S. Cl. CPC H04L 51/08
USPC 709/206

(57) ABSTRACT

Mail processing systems and methods. A method includes scanning a plurality of mailpieces by a mail processing system to produce at least one associated image of each mail piece. The method includes associating each mail piece with a respective recipient and transmitting the associated image of each mail piece to the respective recipients. The method includes receiving a work order for each mail piece from the respective recipients by the mail processing system. The method includes displaying instructions corresponding to the work orders to a user, wherein the user processes the mail pieces according to the instructions.

### TECHNICAL FIELD

The present disclosure is directed, in general, to systems and methods for managing mail pieces and other items in a virtual office environment.

### BACKGROUND OF THE DISCLOSURE

The virtual office (VO) market is generally associated with business centers (e.g. Regus, Davinci, and Alliance) and stores that offer private post office boxes (PO Box Stores) (e.g. Mail Boxes Etc.). These business centers provide many functions but most often provide their customers with office space, meeting rooms, receptionist, and mailroom functionality. These PO Box stores are also multifunctional but most often provide their customers with shipping solutions, copy center and printing functions, mailing supplies, and often private PO Boxes. The VO market is an extension of the core business for both business centers and PO Box stores. The VO market provides these companies both an additional service to offer as well as an additional revenue stream.

The typical VO “customer” that comes to these business centers and PO Box stores can be characterized most often as a small company; for example, a one-person company that works out of his home. Another example of a VO customer, to a lesser degree, may be a company that desires a regional footprint in a city for sales and/or support activities. (Additionally, office usage is trending for companies (from small to large) to consider virtual office usage. Instead of leasing/owning and managing their own office space, they transition into a virtual office environment. This is especially advantageous for companies with employees that are not in the office full-time: employees such as sales staff, customer service staff, and teleworkers. These small companies can be involved in any type of business, but it is common to see professional vocations such as accountants/bookkeepers, attorneys, marketers, real estate, and architects to name a few. The small company, working out of his home, has often sought a separate, external, mailing address from his home address. Historically, this external address would be a United States Postal Service (USPS) PO Box, but in recent times, these small companies have considered alternative options such as a private PO Box at a PO Box store or a virtual office address at a business center. Both alternative options serve the purpose, but the benefit of the virtual office business center is that a prestigious address could be acquired (e.g. Park Avenue in Manhattan), which carries much more cache than a PO BOX type address. Both the business center and PO BOX store act as a commercial mail receiving agent (CMRA) for the VO customer. Included in this capability is the ability to receive packages not sent via the USPS (e.g. FedEx, UPS), a function that cannot be performed by a USPS PO BOX. Additionally, the business center option provides other benefits to the small company beyond acting as a mail receiving agent. These usually include a receptionist to answer phone calls and schedule appointments, office space and meeting room access, WIFI access, copy center functions, video conferencing, and outbound mailing support.

Improved mail handling processes are desirable, particularly in, but not limited to, VO environments.

### SUMMARY OF THE DISCLOSURE

Various embodiments include methods and systems for mail processing. A method includes scanning a plurality of mailpieces by a mail processing system to produce at least one associated image of each mail piece. The method includes associating each mail piece with a respective recipient and transmitting the associated image of each mail piece to the respective recipients. The method includes receiving a work order for each mail piece from the respective recipients by the mail processing system. The method includes displaying instructions corresponding to the work orders to a user, wherein the user processes the mail pieces according to the instructions.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software, or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system 100 in which an embodiment can be implemented, for example, as a mail processing system configured to perform processes as described herein;

FIG. 2 depicts a flowchart of an overall process in accordance with disclosed embodiments;

FIG. 3 illustrates a process for scanning mail pieces, in accordance with disclosed embodiments; and

FIG. 4 depicts an example of a web-portal interface in accordance with disclosed embodiments.

### DETAILED DESCRIPTION

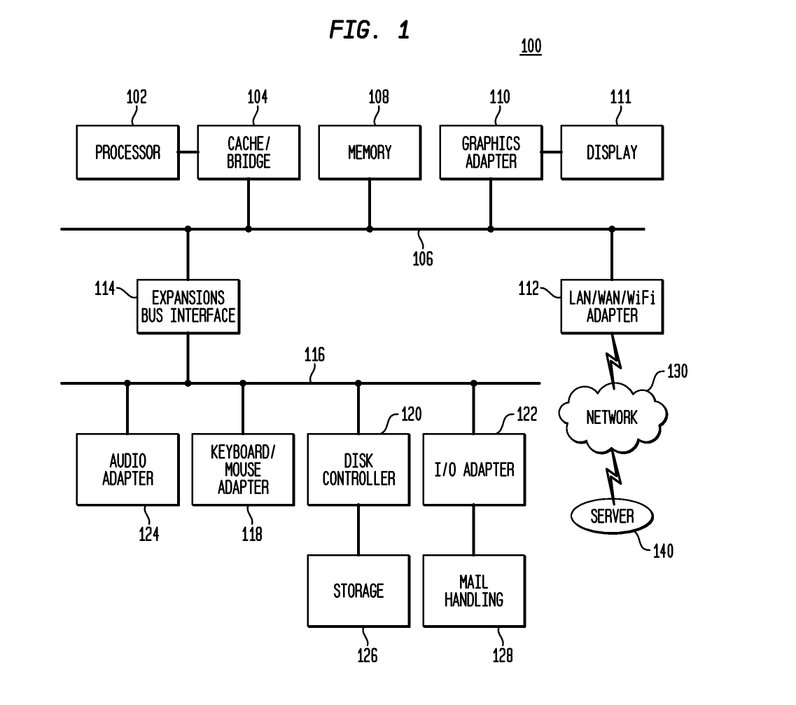

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments provide advantages in processing mailpieces, parcels, and other items while allowing intended recipients to manage the processing and disposal of the physical items.

Mail processing is typically the job function of a front desk receptionist at the business center or a clerk at the PO Box store. The number of customers that a business center has varies greatly from center to center but a typical business center generally has about 50 in-house customers (customers that lease dedicated office space) and 50 to 150 VO customers. For the discussion below, assume the average business center has 150 total customers consisting of 50 in-house customers and 100 VO customers. For PO Box stores, assume about 100 customers with a private PO BOX.

Mail is delivered by the USPS and can arrive at any time of the day, although typically it arrives in the morning. For purposes of illustration, assume that the mail is delivered at 10:00 AM each business day. The amount of mail that arrives varies day to day but is generally one or two USPS flat-sized tubs of mail. This equates to about 100 to 200 mail pieces per day or on average roughly about one mailpiece per day per customer. It is also noted that the mix of mail that arrives can consist of letters, flats, and parcels as well as a mixture of first-class and standard-class (often advertising) mail. Additionally, letters and packages may also arrive via couriers other than the USPS, such as FedEx, UPS, and others.

As described above, the receptionist is responsible for receiving and processing the mail. To effectively process mail, the receptionist must memorize the business center customer list. The extent of this knowledge will include company names, customer names, PMB PO Box numbers, in-house customers versus VO customers, previous customers whose mail still arrives (and must be forwarded per commercial mail receiving agency (CMRA) requirements), as well as special handling requests. These customer-list knowledge requirements on the receptionist present a challenge to the business center owner or manager when it comes to on-boarding new receptionists as new hires or temps filling in on sick days and/or vacations. In general, a long tenured receptionist does a great job on mail; a new hire or temp struggles for a period of time until she better understands the customer list.

For a typical incoming mail handling process, the receptionist receives mail from the USPS letter carrier, typically in tubs. On a piece by piece basis, relying on the customer list learned into memory or referring to a customer database, the mail is fundamentally separated into two stacks: one stack being mail destined for in-house customers; and the other stack being mail destined for VO customers. Disposition of the two stacks is as follows. The stack of mail slated for in-house customers is directly delivered to the customer's office or in some cases to a mail stop (with pigeon or cubby holes) within the business center. The stack of mail slated for VO customers is further sorted and stored by the company. The most common storage means are file folder cabinets with a folder dedicated to each company or a mail stop with pigeon or cubby holes. That is the extent of the incoming mail processing process.

A VO environment can follow a standard process for how mail is delivered or provided to the VO customer. As described above, VO mail is sorted by the company and typically stored in file folders or pigeon holes. The two most common ways VO customers get their mail is to pick it up in person or to have it forwarded to them.

The first method, the “pick it up in person” method, is like it sounds. VO customers visit the business center, approach the receptionist at the front desk, request their mail, at which time the receptionist pulls the customer's mail out of his company's file folder and hands it to the customer. Alternatively, if “pigeon hole” mailboxes are used, the customer either retrieves his own mail directly (much like a USPS PO Box) or has the receptionist access it for him.

The second method, the “forwarding” method, is also like it sounds. This is essentially a forwarding service that involves the receptionist gathering up all of the customer's mail, from either a file folder or a pigeon hole, inserting it into an envelope, applying a shipping label and postage, and mailing it to the customer. Many business centers provide this service on a regular weekly basis. Typically, the forwarding occurs at the end of the week, but customers can also request any day of the week. Often, business centers include this once a week forwarding service in the base cost of the VO offering while other business centers offer it as an option. Additionally, some VO customers request their mail be forwarded on multiple days each week; for example, both Tuesday and Friday. Typically, the customer pays an add-on fee for each additional day. This fee includes labor, the cost of the mailing materials (e.g. envelope, label), and the cost of the postage (often plus a markup).

Another job function of the receptionist is to field VO customers' telephone inquiries about mail stored in the file folders. For example, VO customers may call into the office center and ask the receptionist to check their mail. The customer will either be looking for what they have in general or looking for a specific mail piece in the file folder. For example, the customer may be looking for a check, a contract, or some other document. The business centers often charge for this service on a per event basis.

As a follow-on to the “check my mail” function described above, VO customers often ask the receptionist to either open and scan a specific mailpiece or to priority forward a specific mailpiece or mail pieces. The open and scan function is often requested for an important document that the customer needs access to as soon as possible, such as a contract or a non-disclosure agreement. For this, the receptionist will scan and email the electronic representation of the document to the customer. The customer is typically charged for this service on a per event basis. The priority forward function is requested when the customer desires the mailpiece be forwarded for next day delivery. Much like the additional day regular forwarding service, the customer will be charged for the labor, the materials, and the postage (often with a markup) for this service.

The business center and PO Box stores, when receiving mail for VO customers, act as commercial mail receiving agents in the eyes of the USPS. With being a CMRA comes many rules and regulations. One rule to note that significantly affects the business center is the requirement to continue to forward mail to the VO customer for six months after the VO customers separates from doing business with the business center.

Disclosed embodiments include systems and methods for improved mail handling in VO environments and other environments, described in more detail below.

FIG. 1 depicts a block diagram of a data processing system 100 in which an embodiment can be implemented, for example, as a mail processing system, a VO data processing system, server system, or client/customer system, configured to perform processes as described herein. The data processing system 100 includes a processor 102 connected to a level two cache/bridge 104, which is connected in turn to a local system bus 106. The local system bus 106 may be, for example, a peripheral component interconnect (PCI) architecture bus. Also connected to the local system bus 106 in the depicted example are a main memory 108 and a graphics adapter 110. The graphics adapter 110 may be connected to a display 111.

Other peripherals, such as a local area network (LAN)/Wide Area Network/Wireless (e.g. WiFi) adapter 112, may also be connected to the local system bus 106. An expansion bus interface 114 connects the local system bus 106 to an input/output (I/O) bus 116. The I/O bus 116 is connected to a keyboard/mouse adapter 118, a disk controller 120, and an I/O adapter 122. The disk controller 120 can be connected to a storage 126, which can be any suitable machine usable or machine readable storage medium, including, but not limited to, nonvolatile, hard-coded type mediums such as read only memories (ROMs) or erasable, electrically programmable read only memories (EEPROMs), magnetic tape storage, and user-recordable type mediums such as floppy disks, hard disk drives, and compact disk read only memories (CD-ROMs) or digital versatile disks (DVDs), and other known optical, electrical, or magnetic storage devices. The I/O adapter 122 can be connected to any number of input/output devices, including in particular mail processing or handling equipment 128 that is capable of performing other mail processing functions, including transporting, sorting, scanning, imaging, and other processes that may be useful for processing parcels, letters, packages, flats, and other mail pieces, all referred to as “mail items” herein, whether processed by postal services or private courier or delivery services.

Also connected to the I/O bus 116 in the example shown is an audio adapter 124. The keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. In some embodiments, multiple data processing systems may be connected and configured to cooperatively perform the processing described herein. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

The LAN/WAN/Wireless adapter 112 can be connected to a network 130 (not a part of data processing system 100), which can be any public or private data processing system network or combination of networks, as known to those of skill in the art, including the Internet. The data processing system 100 can communicate over the network 130 with a server system 140, which is also not part of the data processing system 100, but can be implemented, for example, as a separate data processing system 100. In particular, each data processing system 100 can intercommunicate over the network 130 with other systems and servers to perform the communication and data transfer functions described herein.

Disclosed embodiments include systems and methods that implement a “digital mail” solution for VO and other environments. The functions and processes described herein can be performed in addition to and along with the business center environment functions described above.

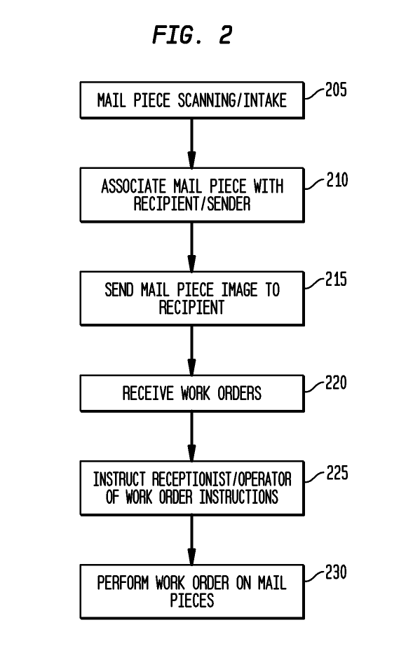

FIG. 2 depicts a flowchart of an overall process in accordance with disclosed embodiments. Additionally, the disclosed digital mail solution process described below is illustrated using three distinct operational processes within the overall process: (1) the scanning operation by the receptionist; (2) the VO customer process; and (3) the work-order process by the receptionist or other person.

Received mail can be first scanned in a scan/intake process (step 205), in accordance with disclosed embodiments. In the description below, “mail” and “mail piece” are generically used to refer to any received letter, flat, package, parcel, or other received item, though the disclosed processes provide particular advantage with document/letter type mail. Scanning can be performed, for example, by the business center receptionist.

The scan/intake process is a process for assigning each mail piece to be processed a (preferably unique) registration ID, optionally labeling each mail piece with its registration ID, producing an image of each mail piece including a bar code or other indicia that includes the registration ID, and storing the image and registration ID in the system. A specific example is described in more detail below.

For the scanning process, the assumption is that the letter carrier has visited the business center and dropped of the mail. It is assumed that the mail arrives in tubs, although, of course, it may arrive in other ways. Mail can arrive, for example, to the business center in the morning and be processed by the receptionist in the morning. Therefore, scanning can also take place in the morning. The “scanning” process can include several other processes as described below.

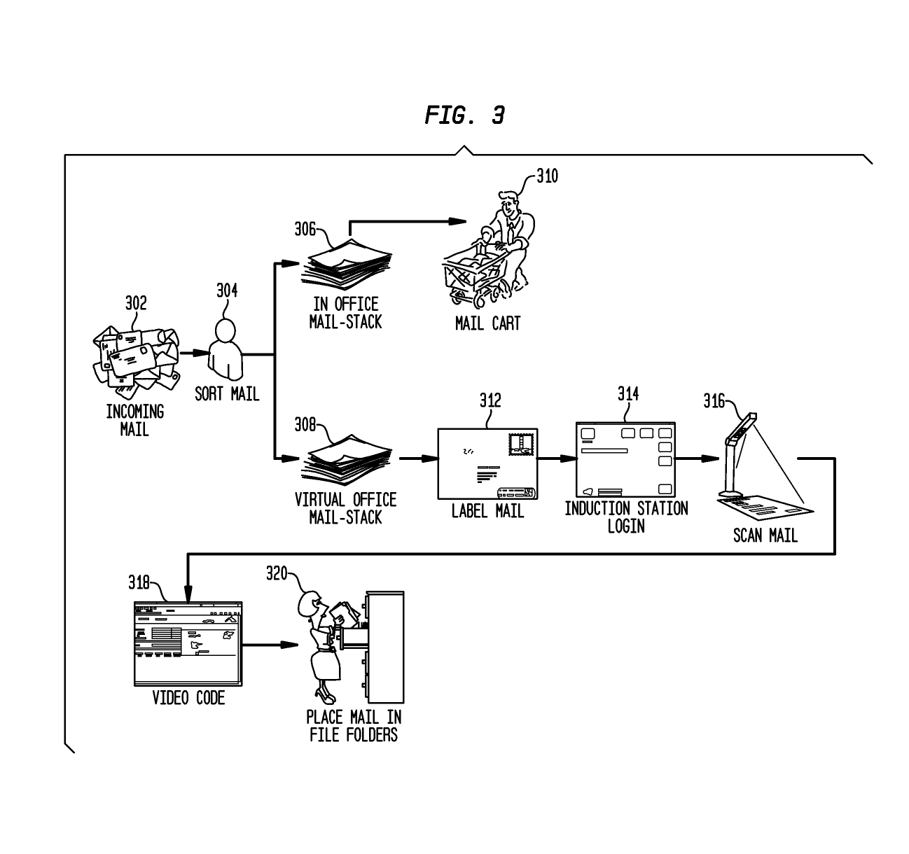

FIG. 3 illustrates a process for scanning mail pieces, in accordance with disclosed embodiments, that can be performed as all or part of step 205.

Scanning can include registration of mail. The registration process consists of getting the mail pieces registered into the digital mail solution.

Upon arrival of the mail, as shown at 302, the receptionist will generally sort the mail, as shown at 304, into two stacks: one stack 306 for in-office customers and one stack 308 for VO customers. Optionally, although not typical, the sorting process may go deeper and additionally sort the mail by customer. This example describes the coarser two-way sort, but it is understood that the process works with a finer company sort. Additionally, this example focuses on VO customers, but it is understood that similar processes can also be used in other environments, including in-company mail processing.

The sorting function at a basic level can be performed as a manual hand sort using the business center customer list to determine whether a customer is in-house or VO. Efficiency in this operation relies on the receptionist having committed the customer list to memory. Otherwise, the receptionist is required to refer to the customer list. Manual sorting is more than acceptable for typical mail volumes associated with business centers.

Other embodiments can use advanced methods of sorting, including using a machine, appliance, or other technology to improve this process. This helps business centers that have higher mail volumes or desire to overcome the requirement for the receptionist to commit to memory the customer list. The machine and appliance approach usually involves using mail sorting and processing equipment. The technology approach involves using technology that assists the receptionist with the decision process as to which stack to sort the mail. Scanning and OCR technology as well as voice coding technology are examples of equipment used to implement such embodiments.

The “in-office” mail can simply be delivered in a conventional manner, as illustrated at 310.

The next step in the process is to associate an identifier with each mail piece in the VO mail stack 308. This is an optional process in that the digital mail solution works both with and without this function, although using the function brings additional benefit.

If using an identifier, the most common method involves applying an identifier label (ID label) to each mailpiece, as illustrated at 312. The label typically contains a registration number represented in either a barcode and/or human readable format. The number is usually numeric but may also contain other characters such as alpha. The primary purpose of the registration number is two-fold. First, it is used as a “license plate” tracking number internal to the digital mail system. Secondly, it is used by the receptionist to visually locate and identify a mailpiece later in the process for processing work orders.

Other methods of registration besides using barcode labels can be used in various embodiments. For example, other techniques can include using the “Fingerprint” technology developed by Siemens Corporation or using a concatenation of the recipient name and address data. The Siemens Fingerprint technology creates a unique fingerprint of the face of each mailpiece. This fingerprint becomes a registration ID within the digital mail solution. The concatenation of the name and address data, acquired using OCR and/or video coding, takes the information within the recipient address block and creates a registration ID within the digital mail solution. The fingerprint can be formed, for example, after the first scanning described herein. The registration identifier is associated with the pattern, location, and/or contents of visible indicia on the respective mail piece that can be derived from the respective images. Other information on the mailpiece, such as the sender address information, may also be attached to the recipient address block information, to create a stronger registration ID. The small potential exists for similar identifiers occurring using this method. Much like in a software hash table where collisions occur, these similar identifiers can be handled.

In this example, barcode labels are applied to the mail by the receptionist as illustrated at 312. Typically, only the mail associated with customers participating in the VO service will get a barcode label. As a result, barcode labels are typically applied after the two way sort (described above) to the VO customers stack of mail. Barcode labels can also be applied to the in-house stack of mail if that business center offers the VO service to that group of customers.

In other embodiments, a barcode identifier to be applied to the mailpiece during the scanning process described below. In this method, the scanner contains the ability to apply a barcode to the mailpiece via a direct spray or imprint on the mailpiece or via application of a label with a barcode.

The ID Label, that includes the registration ID, also presents “branding” opportunities for the office center. Most typically this involves printing the office center name and logo on the label.

The process can optionally receive a user login at an induction station before the system begins scanning/imaging the mail pieces, as illustrated at 314.

The next step in the process is to scan the face of each mail piece. This involves scanning the stack of VO customer mail, as illustrated at 316. In-house customer mail can also be scanned if they are participants in the VO service or if the scanning, OCR, and videocoding can support the separation of in-house and external customers. The outcome of this process is one or more images corresponding to each mail piece.

The determination of what type of scanner is used is driven by multiple factors and requirements such as volume of mail and type of and location of existing scanning equipment.

As described above, typical business centers only receive a tub or two of mail each day. Therefore, manual scanning solutions can be appropriate for this case. These are typically low to medium speed table top scanners. Multiple scanners may be required to scan thin letters and flats as well as thicker letter, flats, and parcels. Ideally, a small table top scanner that supports multiple mailpiece (letters, flats, and parcels) is desired. The Sceye® scanner is an example of a suitable scanner.

Although not typical, business centers with higher volume or who desire faster scanning cycles may select small mail sorters or appliances for automated processing.

A consideration for scanning is the location of the scanner. The typical business center will locate the scanner on or near the receptionist desk. There are several reasons for doing this. First, this is typically where the mail is sorted into stacks. Second, this keeps the receptionist better positioned to support the front desk.

The next step in the process is to scan the ID label (or other indicia) on the face of each mail piece in a video coding process as illustrated at 318 to extract and record the registration ID. This step is part of the registration process internal to the digital mail solution. The image captured in the scan process at 316 can be used as an input into barcode reading module internal to the digital mail solution. As part of an exception process, barcodes that do not read can be relabeled and rescanned.

The video coding process can include performing an OCR process on the image, and associating both the image(s) and the OCR results with the registration ID for that mail piece.

The next step, though not necessarily part of the scanning/intake process, is for the receptionist to put the VO customer mail items into folders or a cubby hole, illustrated at 320. In-house customer mail is part of the VO service, and can be delivered. Enhancements to the existing “put into folder” process can be used in other embodiments. For example, the digital mail solution can assist the receptionist by providing on screen feedback such that the recipient name is associated with the folder or to support the separation between in-house mail and external mail.

Parcels are a special case and can be stored separately when they cannot fit within a folder and/or cubby hole. In this case, a “parcel card” can be employed. This card is essentially a one page document that indicates a parcel has been delivered. The card may have an ID label. The purpose of this card is multifold. First, the receptionist can place the card into the recipient's folder so that when the recipient picks up his or her mail they will see that they have a parcel waiting for them. Secondly, the card can optionally be scanned into the digital mail solution and used to better associate a parcel to the recipient by being used as the mail piece in place of the parcel. It may be advantageous to laminate the parcel card for longevity and reuse.

At this point, each mail piece (or at least those involved in the VO process) has been scanned and “taken in” to the system, and the scanning/intake process of the example of FIG. 3 is concluded.

The system associates the mail piece with the recipient and optionally the sender (step 210). In various embodiments, this can be accomplished using either or both Optical Character Recognition (OCR) and video coding technology. The registration ID, whether ID label, fingerprint ID, or other, is also linked to the recipient. This can include using processes as described below for the system to determine a recipient identifier and optional sender identifier for each mail piece. The recipient identifier and sender identifier can be just the name, the name and address, a code or identifier associated with a known recipient or sender, or otherwise.

When OCR is used, an image of the mail piece is submitted to the OCR which attempts to read the recipient address block. Recipient matching must consider matching a recipient to a name, a company name, a PMB (private mailbox number issued by the USPS), or any combination of the above. The ability to sort to mail stops (e.g. accounting department) may also be required.

Typically a database of VO customer names, such as stored in storage 126, is utilized to support the OCR. The database may originate from a corporate owner of the business center or be manually generated by the receptionist at the business center. Alternatively, the database may be derived from the digital mail solution front end registration process. This data, and any of the data described herein, can additionally or alternatively be stored in a “cloud” storage on a server data processing system, where it is accessible via the Internet.

It may be desired to have an additional database of VO customer names that consists of recipient aliases and abbreviations to increase the effectiveness of the OCR. The alias and abbreviation database can be built many different ways, but in many cases, the alias/abbreviation database can be built manually where either the customer or the receptionist provide/enter the entries. Or, a self-learning database can be utilized where the entries gathered from exception handling (e.g. video coding) are automatically entered into the database.

The system can also subdivide the VO customer database or have an additional database that includes VO customers that “opt-in” and “opt-out” for the digital mail service. Having both databases better supports the OCR process (and video coding) in terms of achieving a higher match rate. This can be important for business centers with low subscription rates especially during introduction of the service at a business center.

OCR exceptions can occur when the recipient information cannot be fully resolved. For this, there are many ways of resolving exceptions, but most often a video coding system can be employed that allows the receptionist to manual key the missing information. Additionally or alternatively, a voice recognition system can also be used to allow the receptionist or other user to verbally enter the missing data.

Optionally the OCR can also recognize the sender's name or address. This information can be later used to display who sent the letter. Furthermore, it could be used to organize the postbox along folders or similar based on the sender's name or address. Also additional information could be read optionally like “priority mail” or “2nd class mail” or any indication which gives a hint to the type of the mail (like ad-mail) in order to support the user later on in the decision to destroy, open/scan, or forward this mail item.

As an alternative to OCR, during the manual sort process, the receptionist can sort mail into customer stacks. Then, for each customer, the receptionist can indicate the customer to the system, which receives the recipient identifier and optionally sender identifier for each mail piece. This can be done using multiple methods such as using the scanning user interface or a sheet with barcodes associated with each customer. After a customer is selected, then the customer scans the stack of mail associated to that customer. This process is performed for each customer. This process is advantageous for several reasons: no OCR required, no video coding, no exceptions, and simplified registration. Also, this method is advantageous to supporting alternative languages beyond English.

The next step in the overall process is to send an image of the mailpiece to the customer recipient (step 215). With completion of the OCR/video coding operation, the digital mail solution system sends an image of the mailpiece to the recipient. This transmission may be either direct via email or indirect via a web portal. For customers using a web portal, this may equate to an email to the recipient informing the recipient that he has mail. Key to this task is an association of the recipient name to a recipient email address.

Whether or not the image is immediately sent to the customer recipient can depend on a customer subscription plan. For certain subscription plans, the images can be sent directly to the customer recipient or made available to him in the web portal. In such a case, the customer may have prepaid a monthly fee, for example, to automatically receive the mail piece images.

However, for other subscription plans, the image may not be automatically sent to the customer recipient. For example, for a “pay as you go” subscriber, with completion of the OCR/video coding operation, the digital mail system can send an alert email to the recipient that does not include the image. This email alerts the recipient that they have received mail today that has been scanned into their account. In this case, the recipient is required to pay a transaction fee to view newly scanned mail, at which point the image is sent to the customer recipient. The recipient can pay the transaction fee to access newly scanned images via a hyper-link in the email or via the web-portal.

The next portion of the overall process illustrated in FIG. 2 is the VO customer process. The VO customer is the second of the three processes from a chronological perspective.

At this point an image of the mail has been sent to the VO customer. This use-vase details how the VO customer can access these digital representations and provide disposal direction back to the digital mail solution.

VO customers have two methods of accessing their digital mail, according to various embodiments; either via traditional email or via a web portal.

Using the email method, the system can send to the recipient an email that includes the image of the mailpiece and the registration ID of the mail piece. The email can also contain action icons for work orders, as described below.

The web-portal method includes a web-based “portal” through which the recipient can view his mail images and take appropriate action; this method can also include apps for smart phones and tablet devices.

Included in both methods is an image of the mailpiece is provided to the VO customer, and the image is associated with the registration ID. Typically the front of the mailpiece is provided but an image of the rear of the mailpiece can also be provided. Other information that can be provided including an estimate of the number of pages within the envelope, mail type such as letter, flat, or parcel, as well as class of mail (first class or standard class).

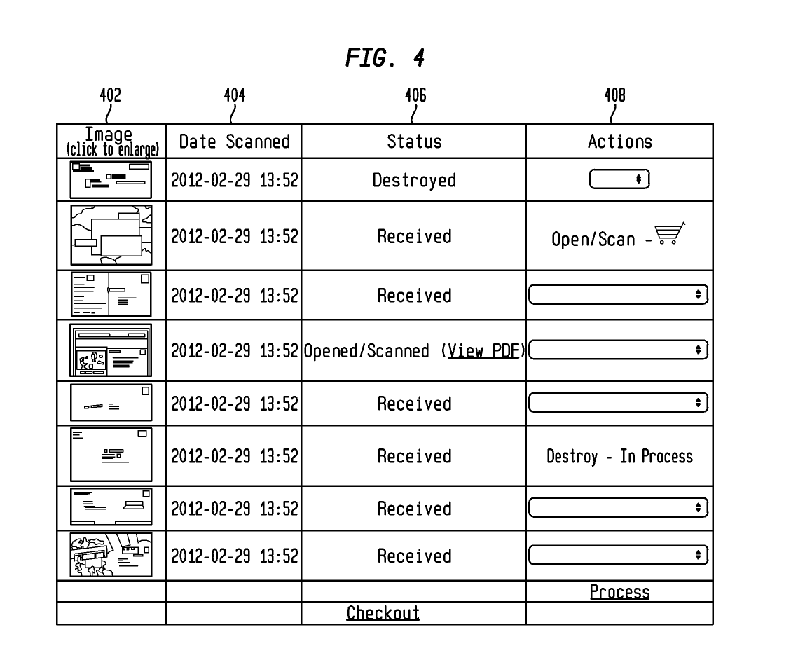

FIG. 4 depicts an example of a web-portal interface in accordance with disclosed embodiments. In this example, the image 402 of each email is shown in thumbnail form; these images can be enlarged by the user by clicking on them. The time and date that each mail piece was scanned is shown at 404; the time of scanning will typically be very close to the time the mail was received at the VO. The status of each mail piece is shown at 406; in various embodiments, the statuses can include received, destroyed, opened/scanned, and others. Available user actions are shown at 408; possible actions or “work orders” are described below.

The web-portal interface can include an “email program” look and feel interface. For each mailpiece, one or more of following columns can be displayed:
A thumbnail image-clicking or pointing on the mailpiece displays a full image;
The registration or scan date and time;
The work order status;
The mail type: letter, flat, or parcel;
The Mail class: first or standard;
The sender's details;
A button or drop-down to request a work order; and
Optionally also other information such as priority mail, ad mail etc.

Other options include sorting by column and hiding mail pieces.

Access to archived mail pieces can be accessed via folders, for example. The system allows to create, rename, and delete folders and to move items into those folders or out of those folders.

Both access methods provide the VO customer with the ability to send mailpiece disposition directions back to be received by the digital mail solution system (step 220). These are known as work orders. These work orders include:
Forward—This means ship the mailpiece to me.
Open and scan—This means open, scan, and ship via email me an electronic representation of the mailpiece.
Open, scan, and destroy—This means open, scan and ship via email me an electronic representation of the mailpiece, then destroy the mailpiece.
Bulk ship—This means ship the mailpiece to me on a regularly scheduled day. Typically this is at the end of the week where all of the mail in the folder is bundled up into an envelope and mailed to the customer Usually the mail is shipped economy but can also be shipped priority is desired by the customer.
Priority ship—This means ship the mailpiece to the customer in an overnight priority manner (e.g. FedEx overnight).
Destroy—This means the mailpiece is not wanted by the customer and the direction is to destroy the mailpiece. Junk mail is common.
Recycle—Same as destroy but the mailpiece is recycled into a controlled recycling program.
Archive—This means digitally archive the mailpiece.
Not for me—This means the mailpiece was mis-drected.

As part of this step, the system can collect all single workorders which are sent by email or by other interface and assign those into different instructions mentioned above.

The final portion of the overall system is the work-order process by the receptionist or other person. Here, after receiving the work orders from the recipient/customer, the system instructs the receptionist/operator to perform the work orders (step 225), for example by printing or displaying the instructions to the operator at the VO. The system can be configured so that the logged-in receptionist gets always the latest list of instructions belonging to one instruction type; for example, a list of all mail items to be recycled.

These work orders, to be performed by the receptionist operator at step 230, are part of a work flow that can be managed by the system. The system can include a work flow management (WFM) application that manages the work flow as described herein, or in other embodiments these tasks can be performed by the VO data processing system.

A service standard can be established at the business center for priority class work orders. These are work orders where the customer expects same day service, such as open and scan, or overnight service, such as priority ship. For this, a deadline time is selected that says any priority class work orders submitted before the deadline will be processed, and that any priority class orders submitted after the deadline will be processed the next day. Typically, a late afternoon deadline time is selected, for example, 3:00 PM, and as a result, WFM for all work orders is typically performed after 3:00 PM each day.

As part of step 225, the WFM application can collect all single work orders and group them according the instruction type, like open/scan work orders, destroy work orders, recycle work orders, etc.

Additionally, a “clock watch” processing can be initiated for each single mail item image sent out to the customer as part of steps 220 or 225. If the customer does not react after a certain defined time span (and so no order is received at step 220), the mail item can be processed according to a defined standard or default work order process at step 230. Normally the mail item will be physically shipped to the recipient. This can happen in case of a holiday, for example, when the recipient does not check his web-portal or email notifications.

The clock watch process is coordinated with the workflow association process and ensures that the default instruction, e.g., for physically forwarding the mail item, is placed on the same work order list as all other workorders for physically forwarding.

The WFM application can include various outputs. In case of a manual service, a workorder list can be printed or displayed on the screen, which shows the mail item ID number or optionally an image of the mail item (in case of Fingerprint) and the instruction what to do with this mail item. Typically, the operator will handle only one type of instruction after another. For example, the operator may first follow all open/scan instructions, then all forwarding instructions, etc. Therefore, the workorders are separated and aggregated based on the instruction type. Each instruction is finished by scanning the ID code again or by typing in a confirmation on the screen. The workflow manager automatically changes the status of the mail item.

In case of an automatic-supported process like the usage of a sorting machine, the workflow manager can directly generate a sort plan in order to support the instructions and sort the mail item to the corresponding sorting bin. After sortation feedback from the machine the processing status is changed.

The processing status can be constantly shown on the user interface of the customer in order to inform him directly.

All mail items to be opened and scanned can be processed by either using an open/scan machine, such as a machine produced by Opex Corporation or other mail handling equipment, or by manually opening the mail item and scanning each page of the content. The status of processing here is only changed if the content is scanned, put back into the envelope or new envelope with the same ID. The workflow manager stores the content of the scans, for example, as a PDF document, together with the other mail piece data based on the same registration ID. The customer will now see the digital scan of the contents in his user interface, email, or web portal.

The WFM application or VO data processing system can implement an “alert” functionality wherein each status change can evoke an event. A typical event could be an email or SMS sent out to the customer in order to inform him about the new status of his request. Also, each status change can signify a completed transaction in the system and can be used for reporting and billing purposes in a click-charge model.

Optionally the WFM application can use any image associated data recognized by OCR, videocoding, or other sensor in order to control the workflow. The WFM application could propose to handle work orders of mail items with priority label first or can warn about mail items which are too heavy or too thick due to the fact that these are probably books or magazines and it does not make sense to scan them completely.

The digital mail solution can include “e-commerce” aspects for monetizing processes described herein. First, VO customers will typically subscribe to the service and pay a monthly fee although some business centers may choose to provide the service at no cost to the customer.

Second, VO customers may be required to pay a service fee for work orders or transactions. For example, free work orders could include: Forward, Destroy, and Recycle. Work orders with a service fee could include: Open and Scan, Open Scan and Destroy, Bulk Ship, Priority Ship, and Archive.

These fees, both subscription fee and work order fees, can be captured using typical web-based typical credit card processing methods. The system can ensure that all transactions which are performed are recorded and can be used for later billing and reporting.

For the VO customer, multiple business models can be offered. In a traditional business model, the VO customer pays a higher monthly subscription fee. For this he gets to see all of his mail but still pays for the typical work orders.

In an à la carte model, the VO customer pays a lower monthly subscription fee. For this, for example, he can not see his email initially and must pay an additional service fee to see his mail as well as pay service fees for the typical works orders.

For the business center, multiple business models can be offered, including a seat-based licensing model and a per-document licensing model.

Various embodiments include a system and method for collecting data of different data input channels like scanner, scale, barcode scanner, which fulfills a process to support the reverse hybrid mail process by sending the image to a processing unit, like OCR or videocoding, in order to obtain recognition data from the image surface. The method can include sending the image and image data to a customer user interface in order to receive instructions, track the workflow status of each mail piece, collect all instructions and organize them in a way to be used for a manual process done by an operator or an automatic process performed by a sorting machine in order to sort the mail items along the instructions, track the fulfillment of the instruction, add any additional data (like content scan) to the data set of the mail item, and record all transactional status changes for reporting and billing.

It is important to note that while the disclosure includes a description in the context of a fully functional system, those skilled in the art will appreciate that at least portions of the mechanism of the present disclosure are capable of being distributed in the form of a computer-executable instructions contained within a machine-usable, computer-usable, or computer-readable medium in any of a variety of forms to cause a system to perform processes as disclosed herein, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

Although an exemplary embodiment of the present disclosure has been described in detail, those skilled in the art will understand that various changes, substitutions, variations, and improvements disclosed herein may be made without departing from the spirit and scope of the disclosure in its broadest form. In the processes described above, various steps may be performed sequentially, concurrently, in a different order, or omitted, unless specifically described otherwise.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for processing mail, performed by a mail processing system, comprising:
scanning a plurality of mailpieces by a mail processing system to produce at least one associated image of each mail piece;
associating each mail piece with a respective recipient, by the mail processing system;
transmitting the associated image of each mail piece to the respective recipients;
receiving a work order for each mail piece from the respective recipients by the mail processing system; and
displaying instructions corresponding to the work orders to a user, wherein the user processes the mail pieces according to the instructions.

2. The method of claim 1, wherein the associated images are transmitted to the recipients by electronic mail.

3. The method of claim 1, wherein the associated images are transmitted to the recipients by an Internet-based web portal.

4. The method of claim 1, wherein the mail processing system is in a virtual-office environment that receives mail intended for recipients that are located elsewhere, and wherein the recipients can thereby remotely access the images.

5. The method of claim 1, wherein the work orders include instructions to scan the contents of a mail piece to produce content images and to transmit the content images to the respective recipient.

6. The method of claim 1, wherein the work orders include instructions to destroy, discard, or recycle a mail piece.

7. The method of claim 1, wherein each mail piece is assigned a respective registration identifier that is associated with the corresponding image and work order.

8. The method of claim 7, wherein each mail piece is marked or labeled with its respective registration identifier before the mailpieces are scanned, and the registration identifiers can be read by the mail processing system from the respective images.

9. The method of claim 7, wherein the registration identifier is associated with the pattern, location, or contents of visible indicia on the respective mail piece that can be derived from the respective images.

10. The method of claim 1, wherein the respective recipients are identified by the mail processing system by performing an optical character recognition process on the images.

11. A mail processing system, comprising:
a processor;
a memory connected to be accessed by the processor; and
mail processing equipment connected to be controlled by the processor, the mail processing system configured to
scan a plurality of mailpieces to produce at least one associated image of each mail piece;
associate each mail piece with a respective recipient;
transmit the associated image of each mail piece to the respective recipients;
receive a work order for each mail piece from the respective recipients; and
display instructions corresponding to the work orders to a user, wherein the user processes the mail pieces according to the instructions.

12. The mail processing system of claim 11, wherein the associated images are transmitted to the recipients by one of electronic mail or an Internet-based web portal.

13. The mail processing system of claim 11, wherein the mail processing system is in a virtual-office environment that receives mail intended for recipients that are located elsewhere, and wherein the recipients can thereby remotely access the images.

14. The mail processing system of claim 11, wherein the work orders include instructions to scan the contents of a mail piece to produce content images and to transmit the content images to the respective recipient.

15. The mail processing system of claim 11, wherein the work orders include instructions to destroy, discard, or recycle a mail piece.

16. The mail processing system of claim 11, wherein each mail piece is assigned a respective registration identifier that is associated with the corresponding image and work order.

17. The mail processing system of claim 16, wherein each mail piece is marked or labeled with its respective registration identifier before the mailpieces are scanned, and the registration identifiers can be read by the mail processing system from the respective images.

18. The mail processing system of claim 16, wherein the registration identifier is associated with the pattern, location, or contents of visible indicia on the respective mail piece that can be derived from the respective images.

19. The mail processing system of claim 11, wherein the respective recipients are identified by the mail processing system by performing an optical character recognition process on the images.

20. A non-transitory machine-readable medium encoded with instructions that, when executed, cause a mail processing system to:
scan a plurality of mailpieces to produce at least one associated image of each mail piece;
associate each mail piece with a respective recipient;
transmit the associated image of each mail piece to the respective recipients;
receive a work order for each mail piece from the respective recipients; and
display instructions corresponding to the work orders to a user, wherein the user processes the mail pieces according to the instructions.
